(19) United States
(12) Patent Application Publication
(10) Pub. No.: US 2020/0410888 A1
(43) Pub. Date: Dec. 31, 2020

(54) SYSTEM AND METHOD FOR EDUCATIONAL INTEGRATION OF GAMING

(71) Applicant: Scott Foster, Ardmore, OK (US)

(72) Inventor: Scott Foster, Ardmore, OK (US)

(21) Appl. No.: 16/810,826

(22) Filed: Mar. 5, 2020

Related U.S. Application Data
(60) Provisional application No. 62/814,284, filed on Mar. 5, 2019.

(51) Int. Cl. G09B 19/00; G07F 17/32

(52) U.S. Cl. CPC G09B 19/00; G07F 17/3244

(57) ABSTRACT

The invention comprises a system for combining educational modules with recreational gaming into an administrative control delivered to users across a network. The invention further comprises the system having a user profile comprising information relevant to the user including educational skill levels, testing information, and a learning path, and even further comprises an administrative control panel for setting rules for each user's interfacing with the system, and further comprises recreational games accessible by users to be played as regulated by the rules; and further comprises educational modules required by rules to be finished by the users, whereby the users acquire additional gaming play by virtue of finishing educational.

### RELATED APPLICATIONS

This application claims priority from U.S. Provisional Application No. 62/814,284 filed on Mar. 5, 2019 and entitled “System and Method for Educational Integration of Gaming,” the entire contents of which are hereby fully incorporated herein.

### BACKGROUND OF THE INVENTION

The invention relates to an improved method and system for improve curriculum and modern learning platforms in learning institutions such as Pre-K through College. The invention further relates to utilizing existing interest by students to create learning incentives. The invention even further relates to a motivation for students who accomplish learning objectives to be rewarded with additional gaming and/or financial rewards. The invention even further relates to a method for giving educators control over more versatile forms and experiences for which students achieve learning objectives and skills both on campus and off campus.

### Field of the Invention

The present invention relates to the fields of providing education services and of web-enabled gaming. The present invention further relates to designing educational programming that cooperatively interfaces with existing and future gaming platforms. The present invention even further relates to a system of giving integrating skills and learning-based curriculum at the same time as interacting with games, the system to be accessible on computers and other personal devices.

### Description of Related Art

The idea of delivering educational content with gaming is a proposition that such content must exist within a game itself, as it is considered more efficient and simplistic from a coding and update management perspective to deliver a single software or content product that combines recreational gaming and educational content. Though companies exist to provide games that support existing educational standards, there is a lack of coordination with the day-to-day educational experience of the student, parents or student stakeholders, teacher and administrators, and the ability to stay up to date with the latest in curricula and gaming trends.

There exists a need to improve curriculum and learning strategies and create an advanced modern learning platform in schools, colleges, and institutions across the US and around the world. It is the duty of schools and learning institutions to build the creative thinkers of tomorrow and challenge students in the most creative ways. There further exists a need for new, creative, and fresh approaches to learning for today's population and technology seeking society. The need also demands buy-in from students, caregivers, parents, and staff for true and total collaboration, excitement, and control. To accomplish this, education service providers must monitor recent games and trends that become the norm of day to day activities. There further exists a need to meet the reality that students of today have acquired the need for constant digital interaction and eliminate the need of students daydreaming waiting for lunch or after school to battle or dream in their game of choice and empower and negotiate that during the day/class time. Having constant digital interaction via gaming outside of school, then much less gaming interaction in school can greatly affect students' ability to listen to a teacher lecture while remaining still and attentive. There further remains a need to standardize the means by which students can learn yet customize the level at which they learn, as students often must cycle through different teachers, substitutes (without appropriate training and certification in many areas), or first year teachers not having contract renewed for poor/lack of performance. There remains a need to avoid leaving children to suffer in their academic progress with outdated and limited learning and with untrained temporary substitutes filling major roles. There remains a need to for students who prove to learn best through certain learning styles to have continued opportunities to further grow academically and educationally through those learning styles. Thus, there remains a further need to bolster emergency certified positions in schools who cannot find enough teachers which lowers the education quality. There remains a need to deploy gaming as a learning platform that provides teamwork, collaboration, creative thinking, problem solving skills, and social interaction. There remains a need to move past antiquated, limited, and long outdated games which are partially inserted into educational curriculum packages that are not appealing to newer generations of students. There is a need for gaming companies to grow into a new level of understanding and provide school support into gaming with all the controls districts desire. There remains a need for a new type of coalition between gaming companies, state and federal education agencies or service providers, efunds/advertising/tokens, schools, and educational software providers.

### SUMMARY OF THE INVENTION

These and other objects were met with the present invention. The present invention provides a system for combining educational modules with recreational gaming into an administrative control delivered to users across a network, the system comprising a user profile comprising information relevant to the user including educational skill levels, testing information, and a learning path; an administrative control panel for setting rules for each user's interfacing with the system; Recreational games accessible by users to be played as regulated by the rules; Educational modules required by rules to be finished by the users, whereby the users acquire additional gaming play by virtue of finishing educational modules; the system further comprising recreational games being controlled/administered with reporting ability based on factors selected from the following group: set minimum/maximum hourly usage and cutoffs, curriculum standards, grade and other subset level settings, skill level, and individual learning needs; the system further comprising a group of user accounts having similar profiles to create similar profile types that tie gaming and curriculum packages into skill levels of predetermined set curriculum areas and/or standardized test scores or learning paths/strands and state or national standards; whereby the rules may have a counter system that allows limiting of recreational gaming; whereby the system may comprise a rewards program selected from the group of coins, skins, credits, and digital currency, whereby schools, users or other permitted stakeholders may purchase and award to users for achievements as selected within the administrative control; the system further may comprise an advertising platform at controlled times during the games or within other aspects of the system for interaction by users; the system may comprise a social interaction capability for users to broadcast or communicate to other users, teachers, or permitted stakeholders; whereby the education modules may comprise with multiple learning suites with custom configuration and settings; the system may further comprise a player vs. player or team vs team game mode, whereby the administrative controls may group the players by age or grade, and the teams by school or city; whereby the rewards program may have the capacity for users to purchase school or non-school items selected from the group comprising of: jerseys, shoes, hats, watches, avatar accessories, and avatar upgrades; whereby the education modules may further comprise video instruction of curriculum package as selected by the user, teacher or user stakeholder; whereby the administrative control may have the capacity to be set by local school district IP, MAC, etc. for notice of type of entity usage or other restrictions; the system further comprising a daily online interaction for schools including a user collaboration or contest; the system further comprising a mentoring module, whereby users may communicate with one another in the system to solve educational modules or challenges in recreational gaming, the mentoring module having a qualification test to qualify a user as a subject matter tutor who may mentor other users for rewards or other incentives; the system further comprising an AR and VR management suite for controlling and viewing screens of students, the suite having the capability to monitor events selected from the group comprising sleeping, daydreaming, or intentionally stalling, changes in body temperature, adverse health conditions, smoking, chewing, drinking, and vaping in AR/VR use with headgear or enclosure.

### BRIEF DESCRIPTION OF THE DRAWINGS

A more complete understanding of the present invention may be derived by referring to the detailed description and claims when considered in connection with the Figures, where like reference numbers refer to similar elements throughout the Figures:

FIG. 1a depicts a diagram of the inventive method.

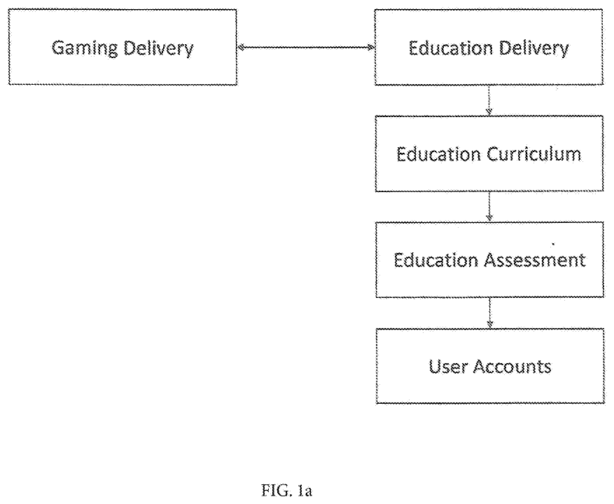

### DETAILED DESCRIPTION OF THE INVENTION

The present invention solves a number of issues with combining students' love of gaming with academic and skills learning. The present invention provides students to instantly and continuously experience benchmark results improving with constant access and shared with a teacher or outside of the educational system, such as of friends/parents for immediate rewards and feedback. The present invention further provides education service providers with the ability to manage student access to recreational games yet incentivize such usage through the educational service platform. The present inventive system provides enable self-paced learning and promote user's success and learning skills/speed. The present inventive further provides all participating popular video-based games as incentive for users to learn, intertwined with the local district/institution during the school day. The present invention provides a system that makes possible to intersperse an entire school day of learning from wake up to bedtime, training students of the future to need/demand these options and curriculum as a constant with controls.

According to the illustrations provided, a method and system of adapting the system are disclosed for implementing existing popular gaming into an educational service provider's network, with administrative controls. User students and staff may have client accounts to access recreational games directly at the originating game access, or through a portal assigned to each user within the educational service provider's network. Users may earn access and continued access to recreational gaming through rules established by the administrators of the educational service provider. In an embodiment of the invention, access may be established by a user meeting one or more learning milestones, completed lessons, or other educational objective set by the administrator. In another embodiment, administrators of the inventive system may assign available games to groups of students, by parental permission, subject area such as math, science, letters, language, et al), by behavior, extracurricular involvement, academic performance, and other groupings of users. Users may be assigned computer hardware and/or VR accessories for gaming use, or log-in credentials that enable remote access outside of an existing lab or even the campus of the educational service provider.

To set up the inventive system within a school's network, it is within the scope of the invention to utilize off the shelf solution such as google classroom, google emails or other student management systems known in the arts to assign, store, or track student information and activities. Such existing software could be used to import user information into the present inventive system stored locally on a server, or via server space contracted out to a 3^{rd} party. In an embodiment of the inventive system, administrators may request reporting of the user's game play, educational module performances, and other data generated through downstream use, rewards information. Such reporting may include time stamps and reports in and by their chosen delivery method, with optional rewards expiration dates if so desirable.

In an embodiment of the inventive process, an administrator may select a control or override within a recreational game so that a user may experience a set time countdown, such as a 30 second timer. The timer may notify user that he or she will need to switch over to educational module, lesson, or other learning objective. In other embodiments, time may be extended or shortened through administrative controls for selected variables. In other embodiments, the faster the user masters the skill, whether in a predictable learning path or one required by administrative control, the faster he or she returns to the recreational game. The administrator of the inventive system may set other rules that connect the user to the outside world. By way of example and not limitation, emergency alerts may be set for automatic or manual interruption or messaging to users, in event of fire, panic or other emergency event that requires the user's separation from game play. Administrators may also broadcast non-emergency messaging that does not interrupt game play, but rather scrolls or appears upon a display screen of the user's current computer/device.

The user or administrator(s) of the inventive system may pause the game to target instruction and start back up for peer interaction and group discussion and real-world examples. The inventive system may comprise building a playing field of selected users which may be separated or combined by state, state curriculum standards, grade, subject, county, etc. and automatically combining said criteria to create a citywide, countywide, statewide, national, or worldwide game based on grade, subject, education level, scores, etc. with many type of grouping based on many available criteria. In a related embodiment, a user may engage in online curriculum meets where students may compete against one another within a given subject.

In another embodiment of the invention, educational service providers may set up controls within the inventive system so that users may earn rewards including digital currency to use for desired or needed goods or services through the earned reinforcement of positive behavior or educational curriculum success. Such rewards may be given to users at selected times, for school-related accomplishments such as for daily attendance, grades, behavior, and other scholastic, leadership or athletic accomplishments. Students may be given control over the rewards to use, and/or administrators may have separate or concurrent control over the ability for rewards to be spent. Control variables for rewards may include temporal (such as daily) limits, per gameplay or summary game limits. Rewards may be optionally set to be available for use in the recreational gaming or educational modules, or in real life. In an embodiment of the invention, users may use rewards to purchase an avatar skin, clothing such as a jersey, accessories or other items/tools to wear in the game representing the user's school/colors or other signifier of school activity. In a related embodiment of the invention, a user who plays recreational games and is registered within the inventive system yet may have the opportunity for rewards and incentives as a result of activities taking place outside of the games and learning modules. For instance, rewards in the form of digital currency, gaming coins, tools, credits, skins, or other incentives may be earned as the user accomplishes a skill or grade at school, opens the door for someone, stops a fight, kind words for someone, helps someone on the bus, picks up trash, or other positive behavior by staff or other administrative stakeholders. Similarly, a user may lose coins or currency through poor behavior or performance according to rules set at administrative controls or through other agreement/consultation with user, parent, teachers, and other stakeholders.

In another embodiment of the inventive system, a user's school staff or leadership, teacher, friend, parent, or community member may further purchase and gift tokens/coins to students by purchasing, donations, sponsorships, and by other alternatives to basic currency transfers. The distribution of virtual prizes and currency may be set to auto transfer pending a future event, for set criteria attendance, grades, test, or semester grades, curriculum accomplishments and other scholastic, leadership and athletic achievements or milestones. In yet another embodiment rewards could further have real world replicas for users to display, such as oversized tokens, certificates, 3d printed objects that symbolize or represent the reward earned by the user.

In still another embodiment of this aspect of the invention, the distribution of rewards comprises type of digital currency (including cryptocurrency) for gaming/schools/public used in or out of schools. Users or students may utilize the digital currency for a purchase of i.e. concessions at a sporting event at home games or away, in the lunchroom, for library fees, yearbook purchases, purchasing items through advertising within the inventive system network, or at participating retail stores in the physical commercial world or via online retail. Admin controls may restrict the amount of purchasing by percentage or stated level. In another embodiment of the invention, the digital currency may be recognized and used within recreational games used to acquire coins, skins, awards and other access or micropurchase fees. The currency may reduce the need for users to carry cash and could be sold, traded, or used again. The digital currency could be set to expire within parameters set by the donor, earner, or administrator benefactor of the digital currency. In other embodiments, the digital currency may part of a closed financial environment that allows growth in value as uniquely designed and desired by amount, subject, year, person, and other parameters. In this embodiment, the virtual coin or currency may be assigned the attributes of the user who first earns it and/or successively possesses it, the reason for earning it, the person or policy responsible for assigning the virtual coin or currency to the user, location of the owners and assigners, and other metadata surrounding the initial creation of that specific unit of currency. Such metadata of the virtual coin and currency may be carried forward in future exchanges between users and others, so that the value of the currency could have an intangible value outside of the stated monetary value for highly sought or even sentimental attributes. For student users, having future access to this metadata could provide sentimental and useful information that captures memories in the learning institution. Useful information could comprise contact information, for example, to give users the means to recall and update donors or track other rewards by user.

Users may be assigned a secure storage locker to store digital assets accumulated through use of the inventive system, in another embodiment of the system. Additional security measures such as biometric, multi-step authentication or other credentials may be required to access, share and utilize such assets. Rewards may be kept in the box, with the ability for 3^{rd} party auditing of the rewards, including digital currency, to be checked in or out of the secure storage locker. Users may further store transcripts, honors, awards, and other digitally-available assets that user may opt to share with recipients. Users may further store photos and other personal files and data as needed.

In yet another embodiment of the invention, schools or other academic institutions may control access within the platform and set rules that, for instance, ensure that first graders are only playing 1st graders from across the US. Schools may set user profiles by email, or login name, IP or MAC range or other subset requirements.

In another embodiment of the invention, the system may comprise an immediate ranking feedback for users. Admin controls may selectively, progressively, or alternatively create a ranking dashboard so that users may use personal computing devices to display standardized scores by school, city, state and nation. In an alternative embodiment, the GUI of the ranking display screen may resemble popular recreational gaming score rankings. In practice, users may track academic and educational progress as a student selected peer group as they compare to other education scores and learning strands. In a related embodiment, for example, placement for subject tests may only occur during school hour with social interaction and tutoring turned off, so that traditional controls for ensuring fair and accurate test taking are maintained.

In yet another embodiment of the inventive system, administrators may selectively enable network wide recognition for users reaching certain benchmarks in a recreational game, such as winning or skill mastering, field, subset, skill, test, and other milestones as set by the administrator, teacher, or other stakeholders. As carried out in use, if a pre-set milestone is met, a notification may be sent administrators office (such as a superintendent, counselor, teacher or principal's office) showing user about to win a recreational Player versus Player tournament, master a recreational game or educational learning strand, field, subset, skill, test or other milestone/achievement. The notification in embodiments of the invention may comprise textual, audio or video alerts. In the case of video, content may be delivered to via streaming applications such as twitch, stream, Instagram, or others selected from a user's dashboard or from administrative controls. An administrator or agent thereof could then opt to feed selected office televisions, monitors, or live social media feeds to stream for other users to watch the final ending while cheering on students. In other embodiments, other student users may comment in game or educational skill challenge as the user turns on twitch or other streaming. In still other embodiments, the highlight streaming mechanism be set to stream automatically start within set parameters, and may further comprising auto inviting or distributing to each user's selected recipients.

In yet another embodiment of the invention, users and parents/other stake holders may select learning an educational skill such as algebra or English from selected from rated teachers in the county, state, or even US. User students or parents may control selection of the teacher, tutor, or mentor according to selected criterion such as other interests of the user, any learning challenges or preferences of the user, and accomplish or master a subject without being bound by location, poverty level, house quality, parental income, social status, etc. In an embodiment of the invention, users or parents/stakeholders of the user may opt to pay or tip an educator or tutor with virtual coins by students, admin, or parents for helping one succeed. In embodiment where the user is algorithmically matched to learning styles that have proven to be successful with that user, tutors who are highly ranked for that or those same learning styles may also be automatically assigned to that same user.

The inventive system in practice may have a number of controls at the school or admin level, having a rules settings interface for educators and institutions the ability to control access, time usage, reports/statistics, award coins, skins, tools, and interact with other video, AR/VR, and/or curriculum solutions from within or pop in and out of the games or even pause it. In an embodiment of the invention, the delivery of rewards and/or summation of learning strands accomplished over a period of time may be tabulated. Groups such as schools, cities, school districts and state-wide entities may thus track performance of user students in short and long term scenarios. It may and track summary statistics of usage, improvement and successful trends and combinations of the recreational gaming, educational modules, and rewards.

In another embodiment of the invention, hints or clues regarding recreational gaming may be delivered as part of the educational module content. Such hints may be delivered by audio or video through the computing device of the user. Though the inventive system envisions creating original educational content and live/recorded teaching modules, it is similarly within the scope of invention to utilize existing educational content for example but not limited to brands such as channel/discover education videos, plato, lexia, odysseyware, acellus, kahoot, brainpop, lexia, splash math, edmentum, curiosity u, tied into planned educational strands so that every student user may enjoy an individual learning path generated by past successes, testing and other metrics selected by administrators of the inventive system. Looking are closely at the auto learning path, users may be required to watch short clips or answer questions or test for baselines throughout learning and create that learning path from within new and popular gaming and curriculum solutions. Applying science, reading, math, and history lessons as interspersed aspects during gaming, as signaled by themes, culture and historical facts of the game in questions, as part of a custom learning path for the user.

In an embodiment of the invention, users' avatar may be used both during the day and at home at night, and similarly for learning paths and subsets of excerpts for targeted instruction with the monitoring ability and/or hourly time limits applied inside or outside of school or learning institution. Thus, users may choose to invest gaming time within the inventive system using their school-based avatar after school to show gains and success the following day/week to friends and to receive further reward-based incentives as discussed infra. Promoting school/social based avatar may limit nighttime usage by gaining controls and working with parents of users. Participating schools implementing the inventive systems tend to have the largest (filtered) most robust computer networks and speeds in most cities and yet the network is unused ½ of every day and every weekend. The same period of unused time of those networks may thus be utilized with the inventive system while users are home. The present invention in practice utilizes unused network and data by making it available to students at home for-use by using district devices/wifi/lan/other data services as is desirable. Similarly, over summer, winter and spring breaks, the inventive system may continue to be utilized by users to continue advancing their educational skills and knowledge.

In an embodiment of the invention, educational service providers defray expenses such as purchasing hardware and accommodating additional server space by requiring users to see, promote, or answer/comment on commercials/ads before receiving said rewards or before starting up the recreational game. The social/advertising rights/cost may be implemented on a per student basis or on a per school basis, opening up valuable revenue stream which may be shareable with the educational service providers. In addition, cost associated fees and virtual coin purchasing within the system may create additional revenue streams for the school, gaming partners, and other service providers to share. Ads like shown on YouTube and others may pop up when a user re-enters the recreational game and/or upon retrieving coins or other rewards. In addition, ad or connection revenue may be created when others view user's content, utilizing twitch/Instagram/snapchat with filters and controls and students at school actually challenging their parents at work to learn, contest, or team collaboration during the day while friends, relatives, grandparents could watch remotely their success, comment, interact, and enjoy the fun they are having. Virtually, many stakeholders associated with the user, with permissions, may be involved with recreational game interaction, educational skills accomplishments and awards assembly, available up to daily or more basis as needed.

In yet another embodiment of the invention, educational service providers may utilize cumulative user counts and requested seats/clients to leverage volume discounts on game access fees, rewards, in-game currency, or other micro-purchases or fees otherwise chargeable to a user.

In another embodiment of the invention, different gaming setups/types of setting, standing, activity based, and others may create timed mandated body motion, or moving parts of the body, and AR and VR embodiments of the present invention create even more of a need to move and take a break from the gaming or overall system. As disclosed previously, administrative controls of requiring breaks from the system are well within the scope of the invention. When using AR and VR (especially with headsets) the need to control one user as well as manage many users will strongly exist while providing a management dashboard/app creating controls for usable student apps, times, with the ability to see and sharing student visors, and mandated curriculum deliverables balanced with gaming time. Students while wearing a VR type headset may also fall asleep or intentionally daydream. In an embodiment of the system, controls may also notify instructors and recognize unresponsive behavior indicative of a user sleeping or just in a daze accidentally or intentionally stalling/wasting time while using VR or AR headsets or enclosures. Monitoring this would require more than just watching eyes and provide important information. There further exists a need to also monitor for increased heart rates and charts/reports of how game/curriculum success and failures affects heart rate/pulse, breathing and temperature. It is possible for monitoring vital signs to see curriculum accomplishments/interaction and compare vitals when success/understanding versus not as a possible precursor to results/score. In an embodiment of the invention, sensors may be deployed within the users work space to detect tobacco use, talking, drinking, smoking, and vaping in VR/AR with headgear or enclosures. Such sensors may be set by administrators to alert multiple alerting types and management systems for single or multi user notifications by location and support many types of alerts by locations/zones/emails/text/alarms as well as audible or vibration reporting systems. Users using headgear at school, business, or home may have further need of notice of events such as visitors at the door or in other vicinity of the user. In another embodiment of the invention, stakeholders in the inventive system may opt for headgear or enclosure sensors to be linked to external security and IOT systems such as doorbell technologies, and other alarm events such as burglar alarms, paging, CCTV system, access control systems, bell or intercom systems, dog alerts, proximal screaming, fire alarm, phone, or other urgent notifying need or technology to respond properly. In the event one of the alarm events occurs, an alert is generated at the user's display, or accessed from VR systems through many ways like vibration, external microphone and sensors on headgear, pop up content which may interrupt or stop current activity and may be centrally controlled and distributed by wired or wirelessly to one or many devices or locations, or standardized emergency notification systems, for law enforcement or other emergency services. Such an inventive system may have rules for immediate emergency response in situations of user security, to predict and notify alarms with above parameters while gaming or using curriculum suite for immediate response by community, law enforcement, security, health or other emergency response.

In yet another embodiment of the inventive system, user students (like in gaming) are enabled to talk, tutor, teach, conference, and collaborate with one another while in the curriculum side or game side or combined side of new system while using or not using VR. Collaboration/tutoring may be shared with advanced controls and saved, catalogued, or recorded for viewing by others. Notes, comments, sketches, and other data or communications may be added to tutoring or collaboration by topic, question, strand for extra help and then viewable by others later or purchased with virtual coins and may be subject to adds. Rather than administering the same lesson to the same students through the many iterations and interactions with so many teachers, the inventive system may include controls to selectively record these events and communication and make available by topic/strand at any time. In this embodiment, users may then open up prior collaboration or previous tutoring sessions before initiating their specific educational module, question or subject and add more comments or sketches and review or rate new, prior, or historic topics. This embodiment of the invention may be setup to require user attempts to meet or pass a strand or standard before user is allowed or re-watch classroom instruction of that day. Students may utilize this interaction as a type of tutoring and team learning, from a fellow user student locally, another district, parent, or local or remote teacher. Positive reviews or rewards such as tokens/virtual/digital coins could be used as a tip or payment to successful mentors or teachers. In this embodiment, the system of comparing user success/knowledge first as a tutor to verify a minimum skill level to tutor a specific topic within a time allotment for each area, and then stops after remote student surpasses or performs to that level of knowledge. Maintaining an active tutoring embodiment of this invention may provide a balance for users who have alternative learning styles.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

What is claimed is:

1. A system for combining educational modules with recreational gaming into an administrative control delivered to users across a network, the system comprising:
A user profile comprising information relevant to the user including educational skill levels, testing information, and a learning path;
An administrative control panel for setting rules for each user's interfacing with the system; and
Recreational games accessible by users to be played as regulated by the rules; Educational modules required by rules to be finished by the users, whereby the users acquire additional gaming play by virtue of finishing educational modules.

2. The system in claim 1, the recreational games being controlled/administered with reporting ability based on factors selected from the following group: set minimum/maximum hourly usage and cutoffs, curriculum standards, grade and other subset level settings, skill level, and individual learning needs.

3. The system in claim 1 further comprising a group of user accounts having similar profiles to create similar profile types that tie one or many gaming and curriculum/assessment packages into skill levels of predetermined set curriculum areas and/or standardized test scores or learning paths/strands and state or national standards.

4. The system in claim 1, the rules having a counter system that allows limiting of recreational gaming.

5. The system in claim 1 further comprising a rewards program selected from the group of coins, skins, credits, and digital currency, whereby schools, users or other permitted stakeholders may purchase and award to users for achievements as selected within the administrative control.

6. The system in claim 1, further comprising an advertising platform at controlled times during the games or within other aspects of the system for interaction by users.

7. The system in claim I further comprising a social interaction capability for users to broadcast or communicate to other users, teachers, or permitted stakeholders.

8. The system in claim 1, the education modules comprising with multiple learning suites with custom configuration and settings.

9. The system in claim I further comprising a player vs. player or team vs team game mode, whereby the administrative controls may group the players by age or grade, and the teams by school or city.

10. The system in claim 5, the rewards program configured for users to purchase school or non-school items selected from the group comprising of: jerseys, shoes, hats, watches, avatar accessories, and avatar upgrades.

11. The system in claim 1, the education modules further comprising video instruction of curriculum package as selected by the user, teacher or user stakeholder.

12. The system in claim 1, the administrative control having the capacity to be set by local school district IP, MAC, etc. for notice of type of entity usage or other restrictions.

13. The system in claim 1, further comprising a daily online interaction for schools including a user collaboration or contest.

14. The system in claim I further comprising a mentoring module, whereby users may communicate with one another in the system to solve educational modules or challenges in recreational gaming, the mentoring module having a qualification test to qualify a user as a subject matter tutor who may mentor other users for rewards or other incentives.

15. The system in claim 1 further comprising an AR and VR management suite for controlling and viewing screens of students, the suite having the capability to monitor events selected from the group comprising sleeping, daydreaming, or intentionally stalling, changes in body temperature, security awareness, environmental inputs and statuses, adverse health conditions, smoking, chewing, drinking, and vaping in AR/VR use with headgear or enclosure.

16. The system in claim 5 further comprising a metadata for the rewards, the metadata selected from a group of purchasing date, purchaser contact information, user contact information, purchaser motivation, and user transfers.

17. The system in claim 1, the educational modules being customized to a learning style that the user has selected or tested into.

18. The system in claim 1 comprising of learning strands, instructor attributes, live or archived, and a licensing fee.

19. The system in claim 5 further comprising a secure storage, the secure storage configured to provide storage of digital assets comprising at least one of rewards, transcripts, awards, photos, and personal files.
